(19) United States
(12) Patent Application Publication
(10) Pub. No.: US 2016/0089772 A1
(43) Pub. Date: Mar. 31, 2016

(54) SCREWDRIVER TOOL HAVING MAGNETIC ASSEMBLY

(71) Applicant: Kuo-Han Liu, TAICHUNG CITY (TW)

(72) Inventor: Kuo-Han Liu, TAICHUNG CITY (TW)

(21) Appl. No.: 14/681,049

(22) Filed: Apr. 7, 2015

(30) Foreign Application Priority Data
Sep. 26, 2014 (TW) 103133550

(51) Int. Cl. B25B 23/12; B25B 15/00

(52) U.S. Cl. CPC B25B 23/12; B25B 15/001

(57) ABSTRACT

A screwdriver tool contains: a connecting rod and a magnetic assembly. The connecting rod includes a tool segment, a threaded section, and a neck section. The magnetic assembly includes a slidable sleeve, a magnetic attracting element accommodated in a front end thereof, and an inserting notch formed therein, wherein a diameter of the inserting notch is greater than a diameter of the threaded section, and the slidable sleeve further has a screwing section formed on a rear end of the inserting notch to screw with the threaded section, a length of the screwing section is less than that of the neck section, the threaded section of the connecting rod is inserted into the inserting notch of the slidable sleeve, and the screwing section of the slidable sleeve is fitted with the neck section of the connecting sleeve.

### FIELD OF THE INVENTION

The present invention relates to a screwdriver tool in which a connecting rod is connected with or removed from a magnetic assembly in a screwing manner to replace the connecting rod easily.

### BACKGROUND OF THE INVENTION

Referring to FIG. 1, a conventional screwdriver bit 10 having a magnetic attracting structure contains: a tool segment 101 and a peripheral groove 102 arranged around an outer wall thereof. A slidable sleeve 11 is fitted with the tool segment 101 of the screwdriver 10 and includes a magnetic attracting element 12 fixed on a front end thereof. The screwdriver bit 10 also includes a C retainer 111 retained in the peripheral groove 102 of the screwdriver bit 10. As removing a bolt element 13, the slidable sleeve 11 is pushed forward, and the magnetic attracting element 12 magnetically attracts the bolt tool 13 securely. Thereafter, the bolt element 13 is pulled away from the screwdriver bit 10, the peripheral groove 102 of the screwdriver bit 10 limits the C retainer 111 of the slidable sleeve 11 to avoid a removal of the slidable sleeve 11 and the magnetic attracting element 12 from the screwdriver bit 10. However, the C retainer 13 is mounted and is removed difficultly, and when the tool segment 101 of the screwdriver bit 10 is broken, the screwdriver bit 10, the slidable sleeve 11, the magnetic attracting element 12, and the C retainer 111 are discarded together, thus wasting these components.

Referring to FIGS. 2 and 3, a conventional screwdriver extension contains a connecting rod 20 with a head portion 201, the connecting rod 20 includes a locking slot 202 defined around an outer wall thereof, a magnetic sleeve 21 made of plastic material, and a magnetic attracting element 22 fixed on the magnetic sleeve 21, wherein the magnetic sleeve 21 has a fitting orifice 211 defined on a first end thereof to fit with the connecting rod 20 and has a retaining portion 212 arranged on a second end thereof to retain with the head portion 201 of the connecting rod 20. In assembly, the magnetic sleeve 21 is forced into the head portion 201 of the connecting rod 20, and the retaining portion 212 of the magnetic sleeve 21 slides in the locking slot 202 of the connecting rod 20. As desiring to remove a screw 23, the magnetic sleeve 21 slides forward so that the magnetic attracting element 22 magnetically attracts the screw 23. However, when the magnetic sleeve 21 is forced into the head portion 201 of the connecting rod 20, the retaining portion 212 of the magnetic sleeve 21 slides across the head portion 201 of the connecting rod 20, and when pulling the screw 23 away, the magnetic sleeve 21 is pulled with the screw 23 so that the retaining portion 212 of the magnetic sleeve 21 is pressed by the head portion 201 of the connecting rod 20 to remove from the head portion 201, and when the magnetic sleeve 21 is forced into the magnetic sleeve 21, the retaining portion 212 of the magnetic sleeve 21 cannot retain with the locking slot 202 of the connecting rod 20 securely. In addition, the magnetic sleeve 21 slides out of the head portion 201 of the connecting rod 20 easily, and the retaining portion 212 of the magnetic sleeve 21 is disengaged from the locking slot 202 of the connecting rod 20 troublesomely. Furthermore, when the head portion 201 of the connecting rod 20 is damaged, the magnetic sleeve 21 and the magnetic attracting element 22 are disposable with the connecting rod 20 together.

The present invention has arisen to mitigate and/or obviate the afore-described disadvantages.

### SUMMARY OF THE INVENTION

The primary objective of the present invention is to provide a screwdriver tool in which a connecting rod is connected with or is removed from a magnetic assembly in a screwing manner to replace the connecting rod easily.

Further objective of the present invention is to provide a screwdriver tool in which the magnetic assembly magnetically attracts a bolt element to avoid a removal of the bolt element from the connecting rod.

Another objective of the present invention is to provide a screwdriver tool in which the slidable sleeve of the magnetic assembly limits a tool segment of the connecting rod to avoid a removal of the magnetic assembly from the connecting rod.

To obtain above-mentioned objectives, a screwdriver tool provided by the present invention contains: a connecting rod and a magnetic assembly.

The connecting rod includes a tool segment formed on a front end thereof, a threaded section around an outer peripheral side thereof adjacent to the tool segment, and a neck section extending outwardly from the threaded section.

The magnetic assembly includes a slidable sleeve, a magnetic attracting element accommodated in a front end thereof, and an inserting notch formed therein, wherein a diameter of the inserting notch is greater than a diameter of the threaded section of the connecting rod, and the slidable sleeve further has a screwing section formed on a rear end of the inserting notch to screw with the threaded section of the connecting rod, and a length of the screwing section is less than that of the neck section of the connecting rod, the threaded section of the connecting rod is inserted into the inserting notch of the slidable sleeve, and the screwing section of the slidable sleeve is fitted with the neck section of the connecting sleeve.

### BRIEF DESCRIPTION OF THE DRAWINGS

FIG. 1 is a cross sectional view of a conventional screwdriver bit.

FIG. 2 is a cross sectional view of a conventional magnetic assembly of a screwdriver tool.

FIG. 3 is another cross sectional view of the conventional magnetic assembly of a screwdriver tool.

FIG. 4 is a perspective view showing the exploded components of a screwdriver tool according to a preferred embodiment of the present invention.

FIG. 5 is a perspective view showing the assembly of the screwdriver tool according to the preferred embodiment of the present invention.

FIG. 6 is a cross sectional view showing the assembly of the screwdriver tool according to the preferred embodiment of the present invention.

FIGS. 7 to 13 are a cross sectional view showing the operation of the screwdriver tool according to the preferred embodiment of the present invention.

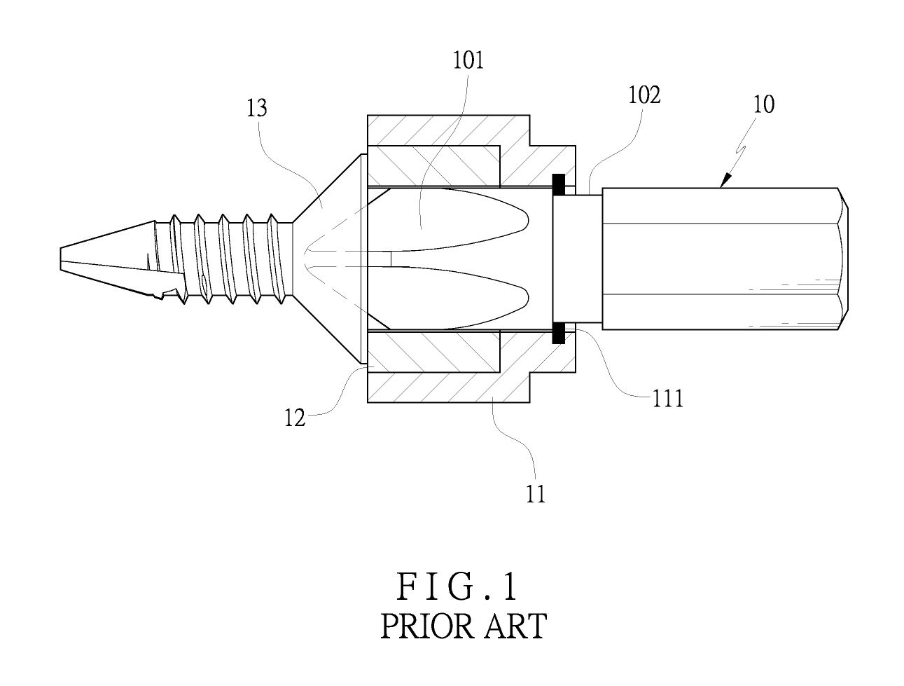

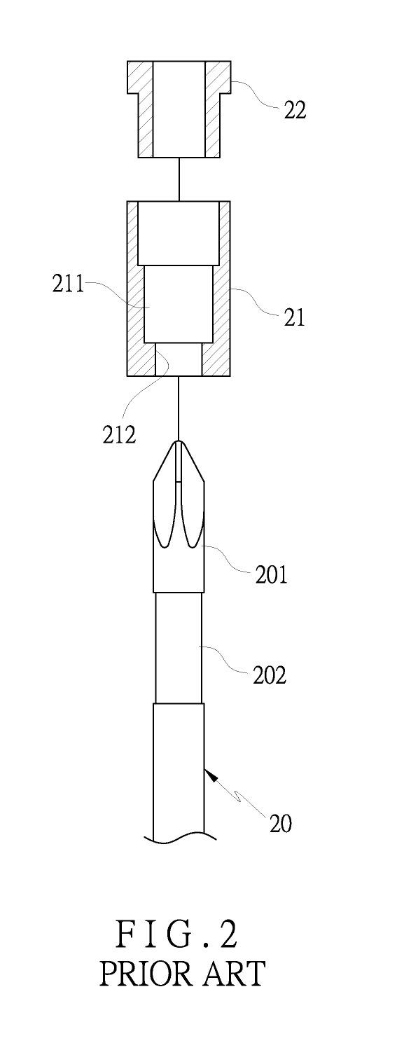

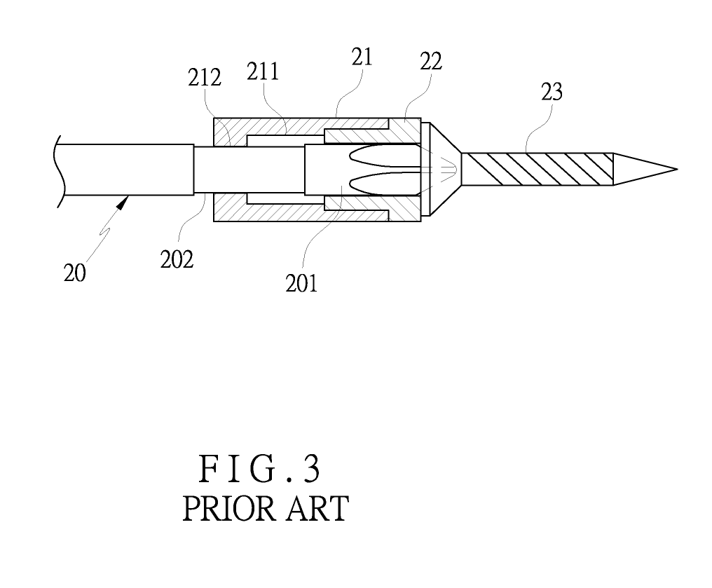

### DETAILED DESCRIPTION OF THE PREFERRED EMBODIMENTS

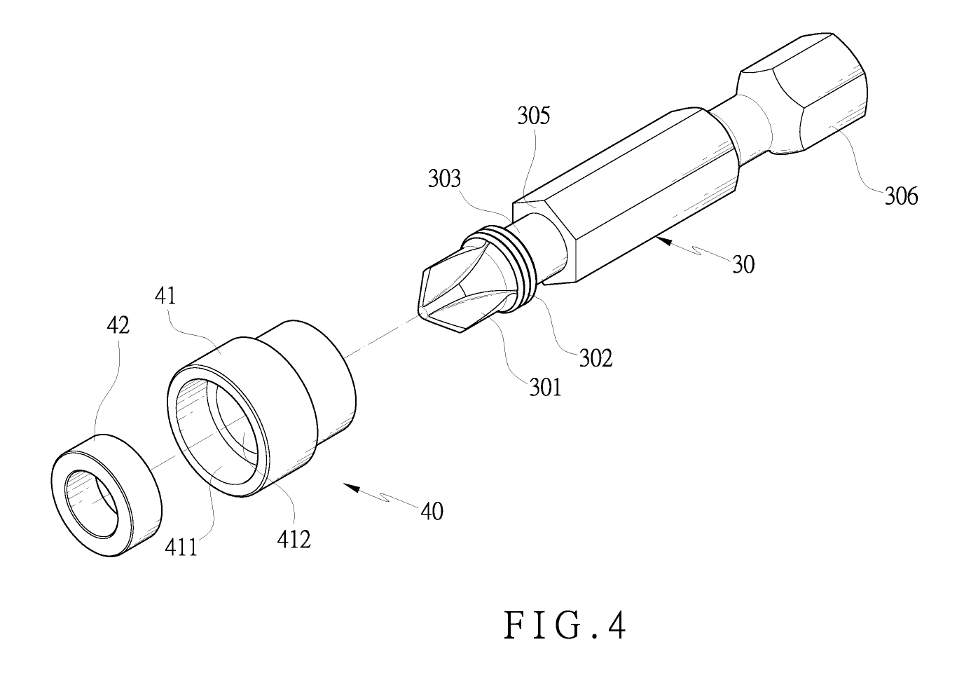

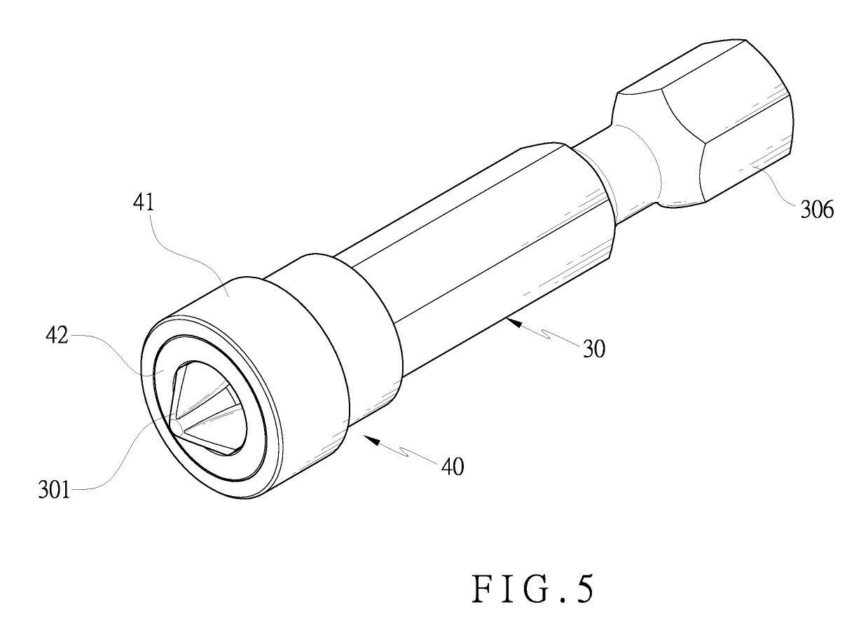

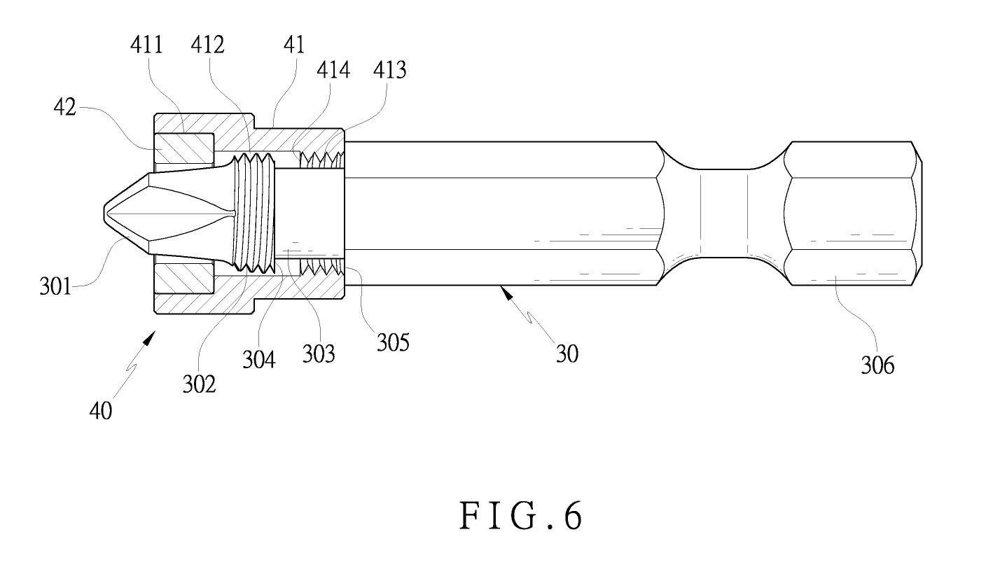

With reference to FIGS. 4 to 6, a screwdriver tool according to a preferred embodiment of the present invention comprises: a connecting rod 30 and a magnetic assembly 40. The connecting rod 30 includes a tool segment 301 of various shapes (such as a cross shape) formed on a front end thereof, includes a threaded section 302 around an outer peripheral side thereof adjacent to the tool segment 301, and a neck section 303 extending outwardly from the threaded section 302, wherein a diameter of the neck section 303 is less than that of the threaded section 302, between the threaded section 302 and a first end of the neck section 303 is defined a first stop face 304, and the neck section 303 has a second stop face 305 defined on a second end thereof. In addition, the connecting rod 30 further includes a hexagonal fitting segment 306 extending outwardly from a rear end thereof to fit with a driving tool. The magnetic assembly 40 includes a slidable sleeve 41, and the slidable sleeve 41 has an accommodating cavity 411 defined in a front end thereof to accommodate a magnetic attracting element 42 formed in a ring shape, the slidable sleeve 41 also has an inserting notch 412 formed therein, wherein a diameter of the inserting notch 412 is greater than a diameter of the threaded section 302 of the connecting rod 30, and the slidable sleeve 41 further has a screwing section 413 formed on a rear end of the inserting notch 412 to screw with the threaded section 302 of the connecting rod 30, and a stepped face 414 defined between the screwing section 413 and the inserting notch 412, wherein a length of the screwing section 413 is less than that of the neck section 303 of the connecting rod 30.

In assembly, the screwing section 413 of the slidable sleeve 41 is screwed with the threaded section 302 of the connecting rod 30, the threaded section 302 of the connecting rod 30 is inserted into the inserting notch 412 of the slidable sleeve 41, and the screwing section 413 of the slidable sleeve 41 is fitted with the neck section 303 of the connecting sleeve 30, the first stop face 304 and the second stop face 305 of the neck section 303 of the connecting rod 30 limit the screwing section 413 of the slidable sleeve 41. Since the diameter of the inserting notch 412 of the slidable sleeve 41 is greater than the diameter of the threaded section 302 of the connecting rod 30, and the length of the screwing section 413 of the slidable sleeve 41 is less than that of the neck section 303 of the connecting rod 30, such that the magnetic assembly 40 limits a movement of the tool segment 301 of the connecting rod 30.

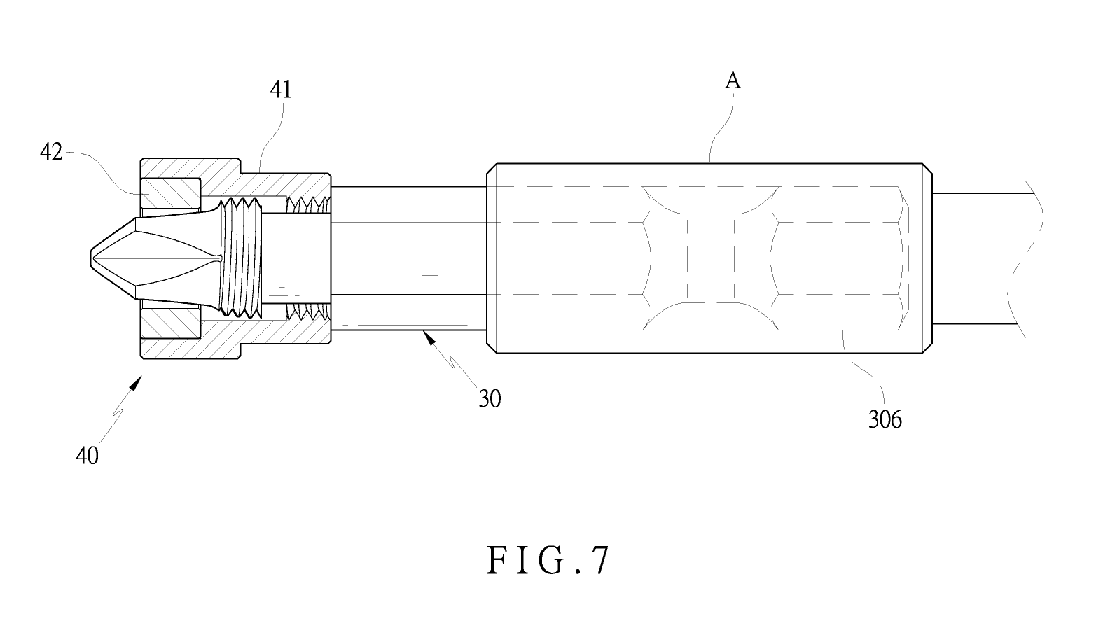

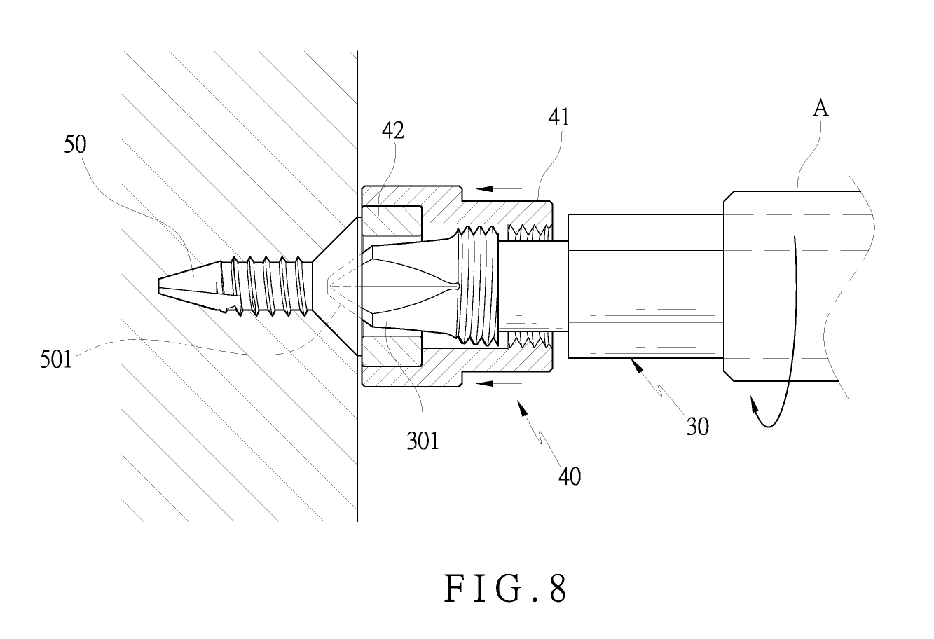

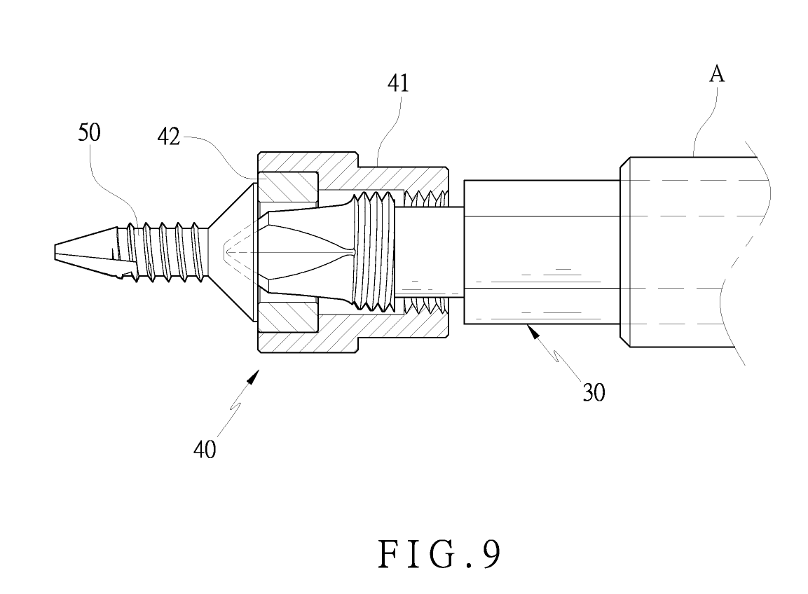

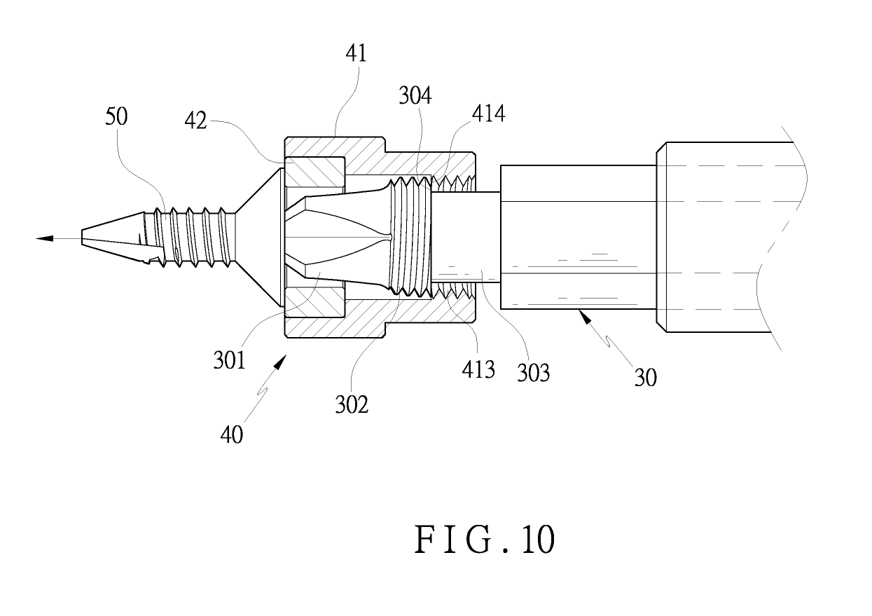

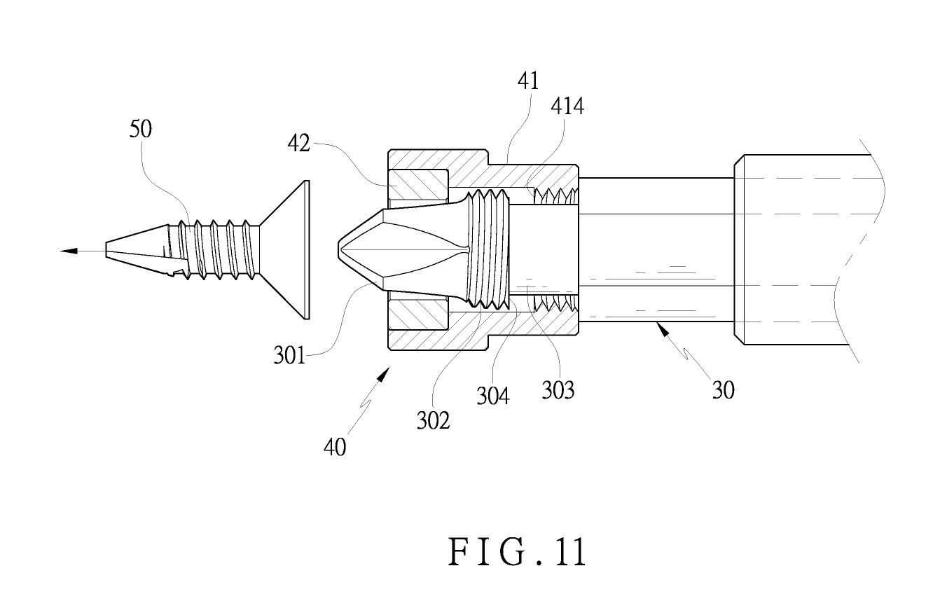

Referring to FIG. 7, in operation, the fitting segment 306 of the slidable sleeve 30 is fitted with the driving tool A to rotate tightly or loosely a bolt element. As shown in FIG. 8, as rotating loosely the bolt element 50, the tool segment 301 of the connecting rod 30 is inserted into a crisscross groove 501 of the bolt element 50, and the slidable sleeve 41 of the magnetic assembly 40 is pushed forward, such that the magnetic attracting element 42 of the slidable sleeve 41 magnetically attracts a head portion of the bolt element 50 and drives the driving tool A to rotate the connecting rod 30, thus rotating the bolt element 50 loosely by using the tool segment 301 of the connecting rod 30. As illustrated in FIG. 9, after the bolt element 50 is removed, it is magnetically attracted by the magnetic attracting element 42 of the magnetic assembly 40. With reference to FIGS. 10 and 11, as desiring to remove the bolt element 50, the bolt element 50 is pulled forward so that the slidable sleeve 41 of the magnetic assembly 40 is magnetically attracted by the magnetic attracting element 42 to move forward, the first face 304 of the neck section 303 of the connecting rod 30 stops the stepped face 414 of the slidable sleeve 41, hence the bolt element 50 is removed and the slidable sleeve 41 of the magnetic assembly 40 limits the tool segment 301 of the connecting rod 30 to avoid a removal of the magnetic assembly 40 from the connecting rod 30.

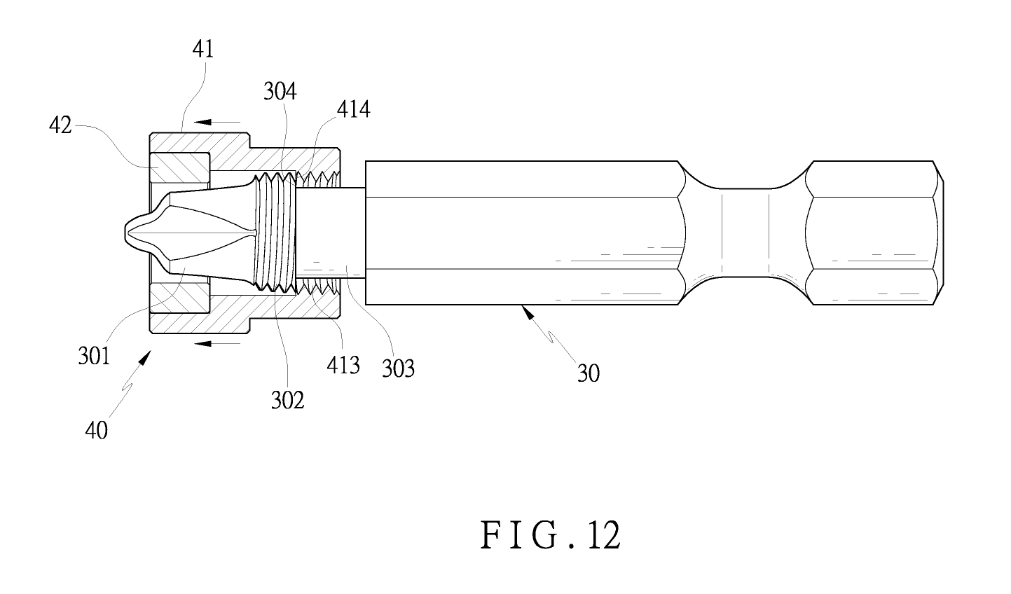

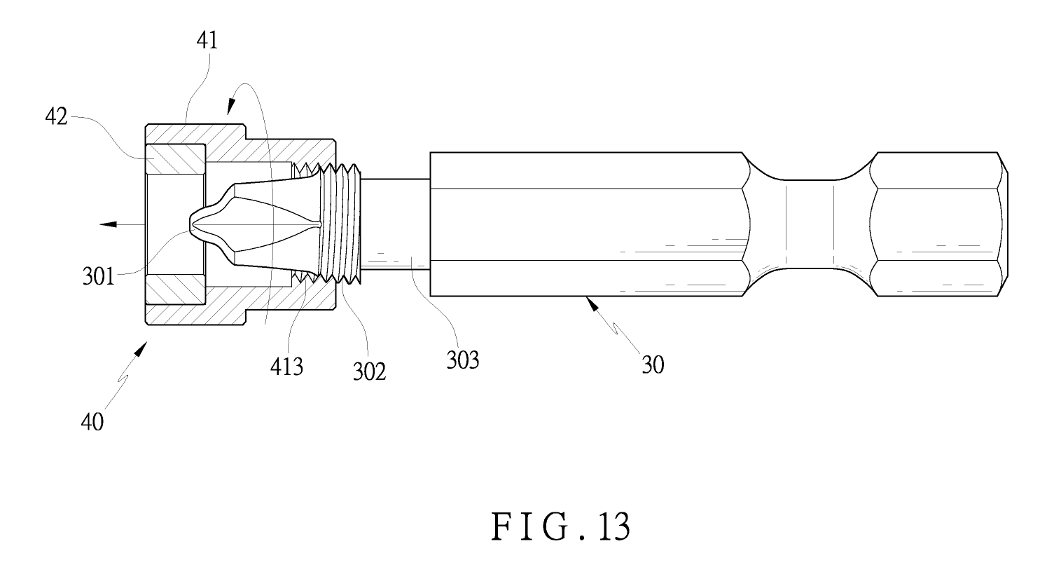

Referring to FIGS. 12 and 13, when the tool segment 301 of the connecting rod 30 is broken, and the connecting rod 30 is replaced, the slidable sleeve 41 of the magnetic assembly 40 is pushed forward so that the stepped face 414 of the slidable sleeve 41 contacts with the first stop face 304 of the neck section 303 of the connecting rod 30, and then the slidable sleeve 41 is rotated, such that the screwing section 413 of the slidable sleeve 41 screws with the threaded section 302 of the connecting rod 30 to release a limitation of the slidable sleeve 41, and then the magnetic assembly 40 is rotated loosely to move away from the connecting rod 30, thus replacing the connecting rod 30. Thereby, the connecting rod 30 is connected with or removed from the magnetic assembly 40 in a screwing manner to replace the connecting rod 30 easily.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A screwdriver tool having a magnetic assembly comprising:
a connecting rod including a tool segment formed on a front end thereof, a threaded section around an outer peripheral side thereof adjacent to the tool segment, and a neck section extending outwardly from the threaded section;
a magnetic assembly including a slidable sleeve, a magnetic attracting element accommodated in a front end thereof, and an inserting notch formed therein, wherein a diameter of the inserting notch is greater than a diameter of the threaded section of the connecting rod, and the slidable sleeve further has a screwing section formed on a rear end of the inserting notch to screw with the threaded section of the connecting rod, and a length of the screwing section is less than that of the neck section of the connecting rod, the threaded section of the connecting rod is inserted into the inserting notch of the slidable sleeve, and the screwing section of the slidable sleeve is fitted with the neck section of the connecting sleeve.

2. The screwdriver tool as claimed in claim 1, wherein between the threaded section and a first end of the neck section is defined a first stop face, and the neck section has a second stop face defined on a second end thereof.

3. The screwdriver tool as claimed in claim 1, wherein the connecting rod further includes a fitting segment extending outwardly from a rear end thereof to fit with a driving tool.

4. The screwdriver tool as claimed in claim 1, wherein the slidable sleeve of the magnetic assembly has an accommodating cavity defined in a front end thereof to accommodate a magnetic attracting element.

5. The screwdriver tool as claimed in claim 4, wherein the magnetic attracting element is formed in a ring shape.

6. The screwdriver tool as claimed in claim 1, wherein between the screwing section and the inserting notch is defined a stepped face.
